(19) United States
(12) Patent Application Publication
(10) Pub. No.: US 2024/0303552 A1
(43) Pub. Date: Sep. 12, 2024

(54) PORTING EXPLANATIONS BETWEEN MACHINE LEARNING MODELS

(71) Applicant: International Business Machines Corporation, Armonk, NY (US)

(72) Inventors: Diptikalyan Saha, Bangalore (IN); Swagatam Haldar, Kolkata (IN)

(21) Appl. No.: 18/180,185

(22) Filed: Mar. 8, 2023

(51) Int. Cl. G06N 20/20

(52) U.S. Cl. CPC G06N 20/20

(57) ABSTRACT

Retraining a model to present a target explanation with a prediction responsive to a source sample. The target explanation being selected from explanations provided by at least two machine learning models. A set of candidate samples is selected from samples generated from a relationship to the source sample. The retaining being performed with the set of candidate samples in a revised training dataset and causing a model presenting another explanation to present the target explanation with the prediction responsive to the source sample.

### BACKGROUND

The present invention relates generally to the field of machine learning models, and more particularly to explainability of decisions.

A local interpretable model-agnostic explanation (LIME) is a local model interpretation technique that approximates any black box machine learning model with a local surrogate model to explain each individual prediction of the underlying black box model. Local surrogate models are interpretable models such as linear regression or decision tree models that are used to explain the individual predictions of a black box model. LIME trains the local surrogate model by generating a new dataset from the data point of interest with the data type being, for example, text, image, or tabular data.

### SUMMARY

In one aspect of the present invention, a method, a computer program product, and a system for importing an explanation from a first model to a second model includes: identifying a sample data point for which a first machine learning (ML) model provides a first prediction with a corresponding first explanation and a second ML model provides the first prediction with a corresponding second explanation, the corresponding second explanation being a target explanation; generating a set of candidate samples within a specified neighborhood of the sample data point; selecting a subset of the candidate samples based on a degree of difference between candidate explanations respectively provided for predictions made by the first ML model and the second ML model for the candidate sample; and retraining the first model by using a revised training dataset including the subset of the candidate samples to cause the first model to provide the target explanation for the first prediction with the sample data point as input.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a system flow view of a second embodiment of a process according to the present invention;

FIG. 5 is a screenshot view showing information that is generated by and/or helpful in understanding embodiments of the present invention; and

FIG. 6 is a flowchart view of a third embodiment of a process according to the present invention.

### DETAILED DESCRIPTION

Retraining a model to present a target explanation with a prediction responsive to a source sample. The target explanation being selected from explanations provided by at least two machine learning models. A set of candidate samples is selected from samples generated from a relationship to the source sample. The retaining being performed with the set of candidate samples in a revised training dataset and causing a model presenting another explanation to present the target explanation with the prediction responsive to the source sample. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as explanations program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

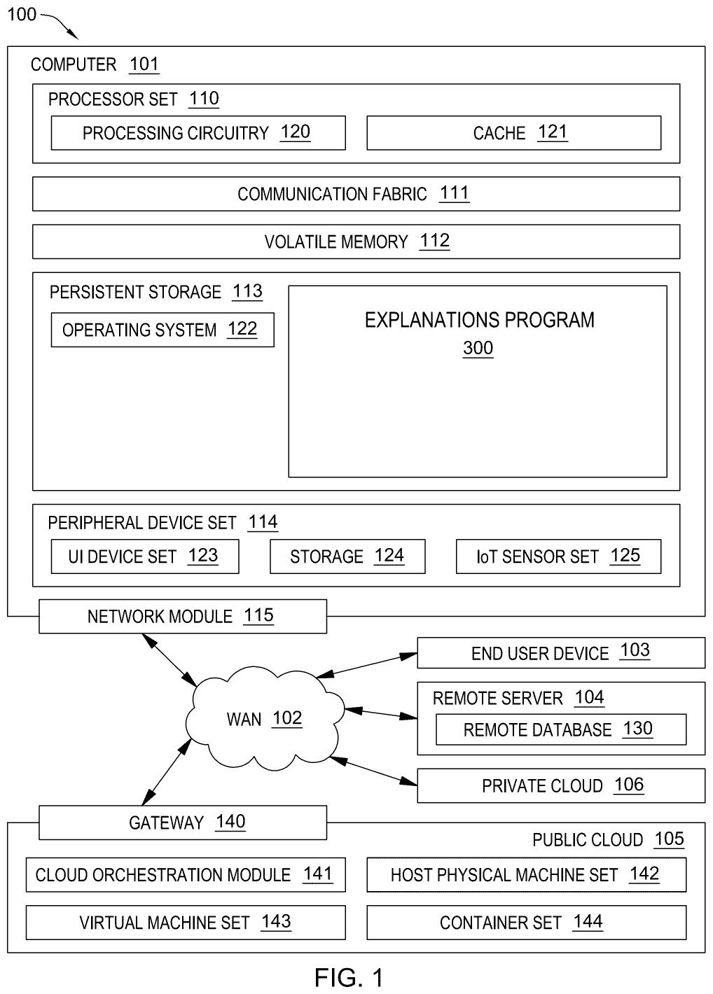

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Explanations program 300 operates to identify a favored explanation output by a local model for specific prediction or decision and to train a target machine learning model to provide the same favored explanation for the specific prediction or decision. Training is performed using a dataset generated from selected candidate samples approximating the source sample that produces the favored explanation by the local model. The candidate samples are selected from a set of generated samples based on a closeness metric comparing the source sample and each generated sample. The value of the closeness metric being above a threshold level of closeness. Candidate samples may be selected from a set of generated samples based on a degree of difference between respective explanations provided by the local model and the target model.

Some embodiments of the present invention recognize the following facts, potential problems and/or potential areas for improvement with respect to the current state of the art: (i) conventional machine learning model repair attempts to retrain the model with a focus on predictive metrics and depends on a ground truth; (ii) conventional data augmentation using model training addresses data imbalance rather than model repair and uses data imputation for missing data; (iii) conventional model merging involves training multiple machine learning models at the same time and averaging predictions; (iv) conventional model repair with feedback rules use fixed rules rather than comparisons with another model with the rules being hand-crafter by a user; and (v) conventional fairness-based model repair change data or labels with a focus on improving fairness of the prediction.

Some embodiments of the present invention recognize the following facts, potential problems and/or potential areas for improvement with respect to the current state of the art: (i) many industrial ML platforms provide explanations along with decisions made by machine learning models; (ii) users trust machine learning models more when the decisions are based on agreeable explanations; (iii) there is a need for incorporating desirable local explanations into models having less desirable explanations for the same decisions; (iv) the increased availability of explanations for decisions made by machine learning models has improved the ability to compare capability of one model to another model; (v) comparisons may now include explanations for decisions as well as the decisions themselves; (vi) machine learning models can be repaired or updated with the local information, such as explanations, from another model; and (vii) if users do not trust a model or a prediction, they will not use it.

Some embodiments of the present invention are directed to porting, or translating, sometimes referred to as importing, a desirable explanation for a decision provided by a local model to another model making the same decision, but for a less desirable explanation. The desirability of an explanation may be based on understandability, language used, or structure of the explanation. For example, a desirable explanation, also referred to as a target explanation, might be easier to understand in that it is more intuitive for a user or client than another explanation.

Some embodiments of the present invention are directed to repairing a target machine learning model, M₁, so that a decision, c1, made by the target model in the decision/explanation pair (c₁, Exp₁) is, instead, based on a favored explanation, exp2, provided by machine learning model, M₂, making the same decision expressed as the decision/explanation pair (c₂, Exp₂). Upon repairing the target machine learning model, the decision/explanation pair for the model M₁ would be (c₁, Exp₂). Several assumptions may apply to effective operation of some embodiments of the present invention. Assumptions may include: (i) the set of training data of the target model M₁ is available; (ii) if the target model M₁ is black-box model, it provides a retrain API with input data; (iii) if the target model M₁ is a white box model, it has updateable weights; (iv) the machine learning model M₂ provides a local model (i.e., provides the explanation of the outcome of sample s) defined by Exp(M₂, s) around the sample s. The local model is interpretable, such as a lasso model, a logistic regression model, or a decision tree model.

According to some embodiments of the present invention, the explanation format is represented as a ranked list of input features and their corresponding weights. An example ranked list is shown in screenshot 502 of FIG. 5, where weighted values for explanation features are arranged from high value to low value.

According to some embodiments of the present invention, the input includes: (i) Model M₁ (black box model); (ii) sample s; (iii) Model M₂ providing the explanation Exp₂ (White box model) (Exp₂(M₂, s)) is another model giving local explanation to the sample s, which is different from explanation Exp₁(M₁, S); (iv) a test dataset, TestSet; and (v) common training data of M₁ and M₂, where M₁(s)=M₂(s). Further, some embodiments of the present invention produce output including a repaired version of model M₁ defined as M₁′, such that: (i) Exp₁′(M₁′, s) is closer to Exp₂(M₂,S) than Exp₁(M₁, S); and (ii) the function difference_accuracy(M₁, M₁, TestSet) is a minimum, where the loss/gain in accuracy between model M₁ and repaired model M₁′ on the test dataset, TestSet is evaluated globally.

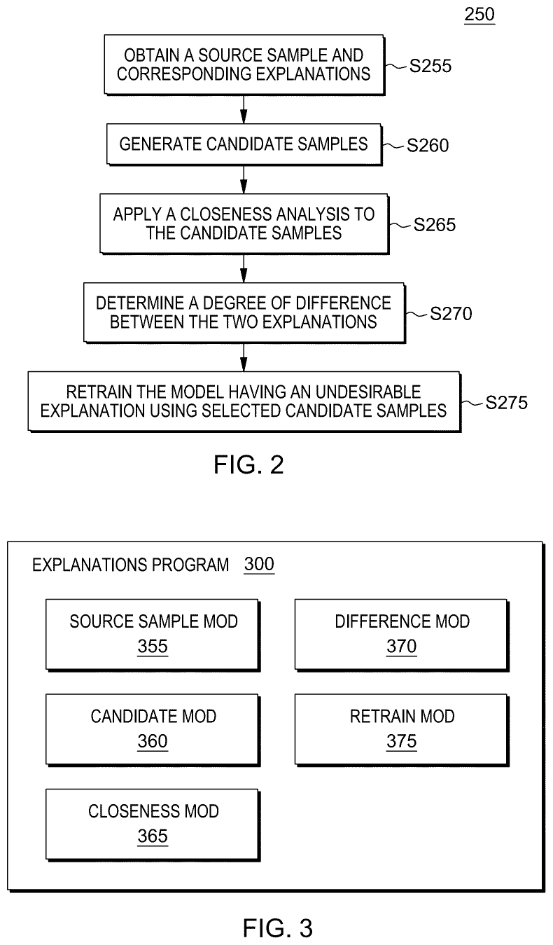

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where source sample module (“mod”) 355 obtains a source sample and corresponding explanations. In this example, the source sample mod obtains a source sample for which the first machine learning (ML) model and the second (ML) model provide different explanations, each explanation being provided along with a same prediction when input with the source sample. At least one of the ML models provides access to the training data on which the model is trained.

Processing proceeds to step S260, where candidate mod 360 generates candidate samples. In this example, the candidate mod generates candidate samples within a neighborhood function of the source sample. According to some embodiments of the present invention, the neighborhood refers to a relatively small area or sphere surrounding the source sample data point. Typically, the source sample is taken as the center of a gaussian distribution (mean), and the standard deviation of that distribution (0.01 to 1 in most cases) gives a rough estimate of the size of the neighborhood, with larger standard deviation values indicating larger neighborhoods around the source sample data point. The term “neighborhood” as used herein is a term in common use with respect to local interpretable model-agnostic explanation (LIME).

Processing proceeds to step S265, where closeness mod 365 applies a closeness analysis to the candidate samples. In this example, the closeness analysis determines a closeness level between the source sample and each candidate sample. A threshold closeness may be applied to select a closest set of generated samples. The closeness level of a given sample is used when selecting a subset of candidate samples from the generated samples.

Processing proceeds to step S270, where difference mod 370 determines a degree of difference between the two explanations. In this example, the degree of difference is determined among explanations respectively provided by the first ML model and the second ML model for the candidate sample. The determined difference may be used when selecting a subset of candidate samples from the generated samples.

Processing ends at step S275, where retrain mod 375 retrains the model having an undesirable explanation with the selected candidate samples. In this example, the second model is retrained using the subset of the candidate samples so that the second model should provide a same explanation as the first model provides for the source sample.

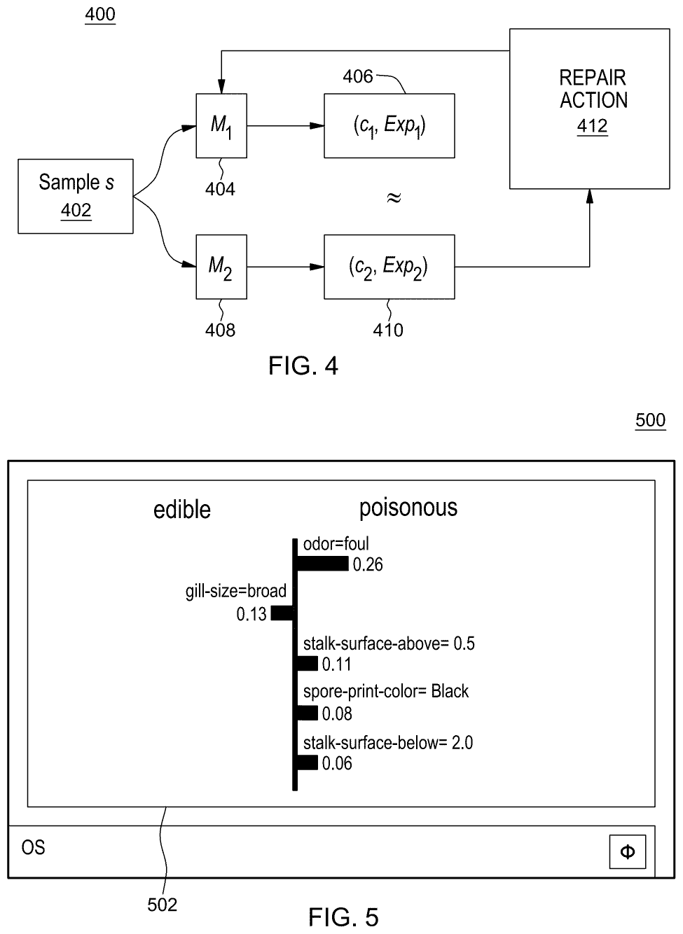

Further embodiments of the present invention are discussed in the paragraphs that follow and with reference to FIGS. 4-6.

FIG. 4 shows system flow 400 depicting a second method according to an embodiment of the present invention. System flow 400 includes, for example, sample data point 402, machine learning model 404, decision/explanation block 406, machine learning model 408, decision/explanation block 410, and repair action 412.

In process 400, sample s, 402 is input to two models, model 404, a global machine learning model, and model 408, a local surrogate model. Each model outputs a prediction c and corresponding explanation Exp. In this example, the explanation from local model 408 is more desirable than the explanation from model 404. Accordingly, repair action 412 is taken to repair the explainability of prediction c of model 404, (c₁, Exp₁), by using the output 410, (c₂, Exp₂), of model 408. Upon training model 404, the output 406 will more closely match the output 410, such that the output 406 is (c₁, Exp₂) or, at least the explanation Exp₁ more closely resembles Exp₂.

Referring now to FIG. 5, computer display 500 shows screenshot 502 according to some embodiments of the present invention. In this screenshot, explanation features and their corresponding weights are presented in a ranked list from highest to lowest. In this example, the highest weighted explanation leads to a prediction of “poisonous” while the second highest weighted explanation leads to a prediction of “edible.”

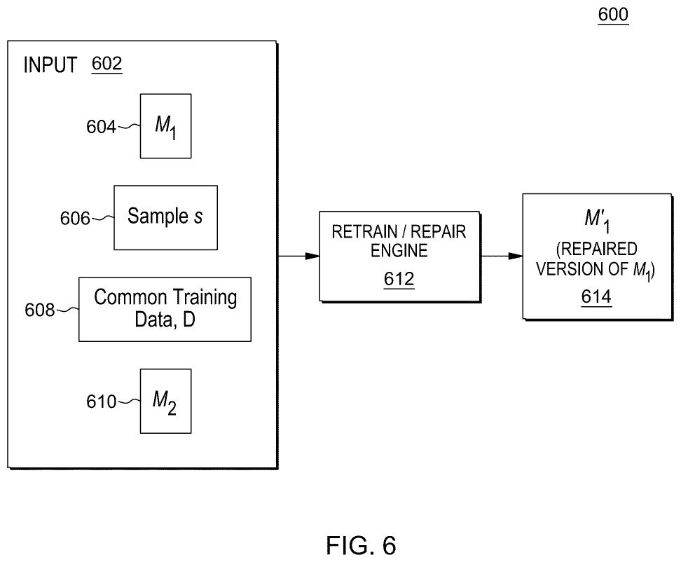

FIG. 6 shows system flow 600 depicting a third method according to an embodiment of the present invention. System flow 600 includes, for example, data input module 602, machine learning models 604, 610, source sample 606, training dataset for models M₁ and M₂ 608, retrain/repair engine 612, and repaired target model 614.

System flow 600 begins with an input set provided by input module 602, the input set including models M₁ 604 and M₂ 610, sample data point s 606, and common training data set D 608. Explainability is evaluated for explanations of predications or decisions made in view of the sample data point s. Upon determining a difference in the explanations, a preferred explanation of model M₂ is used by retrain/repair engine 612 for retraining the model M₁. The retrained model M₁ 614 outputs an explanation of prediction c responsive to input sample s with the preferred explanation of model M₂. For example, the output of model M₁ may be (c₁, Exp₂), where the output of model M₂ is (c₂, Exp₂) with the prediction c₁=c₂, and Exp₂ being the preferred explanation.

Following operations to retrain/repair model M₁ to create M₁′, certain target characteristics may be present as follows: (i) the explanation Exp₁(M₁′, s) is similar to, if not identical to, the explanation Exp₂(M₂, s), alternatively, according to some embodiments of the present invention, the explanation Exp₁(M₁′, s) is a closer match to Exp₂(M₂, s) than the original explanation Exp₁(M₁, S)); (ii) the accuracy loss, if any, between model M₁ and the retrained model M₁ is minimalized when the technique described herein is applied; and (iii) explanations of other decisions based on other samples remain unchanged.

Some embodiments of the present invention are directed to a system for importing a local explanation, that is, an explanation from another model, to repair a global model, such as a black box model, or even a white box model. The explainability of the decision is repaired with a focus on obtaining a better, or more desirable, explanation for the decision being made.

Some embodiments of the present invention are directed to selectively choosing generated samples from a black box model, the samples generated as being in the neighborhood of the source sample for which a desired explanation is provided by a local model. Alternatively, some embodiments of the present invention are directed to using an explanation from another model to constrain the gradient of a white box model. Accordingly, the explanation for some instances is guided by the explanation of another model.

Some embodiments of the present invention are directed to a black box solution wherein samples are generated about the data point s and predictions are taken from a desired explanation, Exp₂; a subset of samples (budget=L) are chosen that are the most effective in changing the explanation of the target model M₁; and the target model M₁ is retrained by augmenting the subset of samples with the original training data. The samples are generated in the neighborhood of sample x₀ as shown in the following equation:

S={x|x∈N(x₀)}

where S is the generated sample set including x, which is a generated sample belonging to the neighborhood function, N, that includes the source sample x₀. The source sample x, is the sample from which Exp₂ is derived when making prediction c.

If there is a budget of L samples to select from the set of S generated samples to update the model M₁, the following equation would apply:

$${S}_{L} = {{arg max}_{{S}^{′} ⊆ S ,}}_{\vert {S}^{′} \vert \leq L} {\sum }_{x ∈ {S}^{′}} ( {w}_{1} \frac{1}{d ( x , {x}_{0} )} + {w}_{2} {D}_{exp} ( {M}_{1} ( x ) , {M}_{2} ( x ) ) )$$

In this way, a subset of examples are selected using a subset search algorithm such that the examples include: (a) samples x closest to the sample x₀ (weighted by the distance d between them); and (b) samples (x) whose explanations (from M₁) are maximally different from that from M₂ (guided by Dₑₓₚ comparing the distances between the two explanations), where w₁ and w₂ are tuneable weights to suitably balance these two factors.

The output is retraining data to feed into the provided retrain API for the model M₁.

Output D=Dₜᵣₐᵢₙ U_{SL}

Some embodiments of the present invention are directed to a white box solution wherein, assuming the model M₁ to be a white box differentiable model, the model is retrained as M₁ to update the weights by minimizing the total objective as follows. Where there is white box access, direct optimization may be performed for the intended objectives of close explanations and minimal loss in accuracy of the model M₁: Starting with a sample data point x₀ around which the model M₁ is to be repaired:

$${L}_{1} = {D}_{exp} ( {M}_{1}^{′} ( x ) , {M}_{2} ( x ) ) for all {‖ x - {x}_{0} ‖}_{p} \leq τ$$

$${L}_{2} = {l}_{m} ( {M}_{1}^{′} ( x ) , {M}_{1} ( x ) ) for all {‖ x - {x}_{0} ‖}_{p} > τ$$

where the total objective is

$$L = {w}_{1} * {L}_{1} + {w}_{2} * {L}_{2}$$

and the repaired model is M₁′=argmin_{M}_{₁} L. Initially, the unrepaired model is equal to the repaired model, M₁=M₁, so L₁ is relatively high because the explanations are different, and L₂ is zero, where L₁ is the explanation dissimilarity loss, and L₂ is the prediction mismatch loss, which is the SoftMax classification with cross-entropy loss (SoftMax CE) for classification. (Note: the term(s) “SOTFMAX” and “SOFTMAX CE” may be subject to trademark rights in various jurisdictions throughout the world and are used here only in reference to the products or services properly denominated by the marks to the extent that such trademark rights may exist.)

Some embodiments of the present invention may include one, or more, of the following features, characteristics and/or advantages: (i) repairs feature attribution based explanations; (ii) compares explanations from two different models; (iii) uses both sample generation and subset selection strategy; (iv) modifies and/or repairs explanations that a user can trust for specific business processes; and (v) retrains an already trained model.

Some embodiments of the present invention are directed to comparing explanations of the two models by

L₁/L₂

to define the distance between the coefficients of the explanation vectors.

Some embodiments of the present invention are directed to a computer-implemented method for importing an explanation from a first model to a second model including operations of obtaining a source sample for which the first model and the second model provide different explanations, each explanation being provided along with each model's prediction for the source sample, generating candidate samples in the neighborhood of the source sample, selecting a subset of the candidate samples by using a closeness between the source sample and each candidate sample and a degree of difference between explanations respectively provided by the first and the second models for the candidate sample, and retraining the second model by using the subset of the candidate samples so that the second model should provide a same explanation as the first model provides for the source sample.

Some embodiments of the present invention are directed to a computer-implemented method for importing an explanation from a first model to a second model including operations of obtaining a source sample for which the first model and the second model provide different explanations, each explanation being provided along with each model's prediction for the source sample and retraining the second model so that the explanation of the second model should be close to the explanation of the first model for samples close to the source sample and a difference between a prediction of the second model and a predication of the updated second model should be minimum for samples not close to the source sample.

According to some embodiments of the present invention, each explanation is represented as a ranked list of input features of each model and weights respectively corresponding input features.

Some embodiments of the present invention do more than joint model training wherein during parallel training of machine learning models, information can be passed between the first machine learning model and the second machine learning model.

Some embodiments of the present invention are directed toward a method for importing an explanation from a first model to a second model, the method including obtaining a source sample for which the first model and the second model provide different explanations, each explanation being provided along with a prediction from each model for the source sample.

Some embodiments of the present invention are directed toward selecting a subset of the candidate samples by using a closeness between the source sample and each candidate sample and a degree of difference between explanations respectively provided by a first and a second model for the candidate sample and retraining the second model by using the subset of the candidate samples so that the second model should provide a same explanation as the first model provides for the source sample.

Some embodiments of the present invention are directed toward retraining a second model so that an explanation of the second model is close to an explanation of a first model for samples close to a source sample and a difference between the prediction of the second model where the prediction of the updated second model is a minimum for samples not close to the source sample.

Some embodiments of the present invention are directed toward representing each explanation as a ranked list of input features of each of two models and weighting respectively corresponding input features of the models.

### Some Helpful Definitions Follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as may be being new, this understanding, as indicated by use of the term “present invention,” is tentative and provisional and subject to change over the course of patent prosecution as relevant information is developed and as the claims are potentially amended.

Embodiment: see definition of “present invention” above-similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a sample data point for which a first machine learning (ML) model provides a first prediction with a corresponding first explanation and a second ML model provides the first prediction with a corresponding second explanation, the corresponding second explanation being a target explanation;
generating a set of candidate samples within a specified neighborhood of the sample data point;
selecting a subset of the candidate samples based on a degree of difference between candidate explanations respectively provided for predictions made by the first ML model and the second ML model for the candidate sample; and
retraining the first model by using a revised training dataset including the subset of the candidate samples to cause the first model to provide the target explanation for the first prediction with the sample data point as input.

2. The computer-implemented method of claim 1, wherein selecting the subset of the candidate samples is further based on:
a closeness value comparing the sample data point to each candidate sample being above a threshold level of closeness.

3. The computer-implemented method of claim 1, wherein:
the first ML model is a whitebox model capable of being directly repaired; and
further comprising:
constraining a gradient of the whitebox model with the target explanation, causing a corresponding explanation of the first prediction to be the target explanation.

4. The computer-implemented method of claim 1, further comprising:
selecting the second explanation as the target explanation based on user input.

5. The computer-implemented method of claim 1, wherein each explanation is represented as a ranked list of input features of each model and weights respectively corresponding input features.

6. The computer-implemented method of claim 1, further comprising:
modifying a first training dataset by which the first ML model was trained to include the subset of the candidate samples to create the revised training dataset.

7. The computer-implemented method of claim 1, wherein:
the first model includes a retrain application programming interface (API) with input data; and
the second model provides a local model around the sample data point, the local model being an interpretable model.

8. A computer program product comprising a computer-readable storage medium having a set of instructions stored therein which, when executed by a processor, causes the processor to perform a method comprising:
identifying a sample data point for which a first machine learning (ML) model provides a first prediction with a corresponding first explanation and a second ML model provides the first prediction with a corresponding second explanation, the corresponding second explanation being a target explanation;
generating a set of candidate samples within a specified neighborhood of the sample data point;
selecting a subset of the candidate samples based on a degree of difference between candidate explanations respectively provided for predictions made by the first ML model and the second ML model for the candidate sample; and
retraining the first model by using a revised training dataset including the subset of the candidate samples to cause the first model to provide the target explanation for the first prediction with the sample data point as input.

9. The computer program product of claim 8, wherein selecting the subset of the candidate samples is further based on:
a closeness value comparing the sample data point to each candidate sample being above a threshold level of closeness.

10. The computer program product of claim 8, wherein:
the first ML model is a whitebox model capable of being directly repaired; and
further comprising:
constraining a gradient of the whitebox model with the target explanation, causing a corresponding explanation of the first prediction to be the target explanation.

11. The computer program product of claim 8, further causing the processor to perform a method comprising:
selecting the second explanation as the target explanation based on user input.

12. The computer program product of claim 8, wherein each explanation is represented as a ranked list of input features of each model and weights respectively corresponding input features.

13. The computer program product of claim 8, further causing the processor to perform a method comprising:
modifying a first training dataset by which the first ML model was trained to include the subset of the candidate samples to create the revised training dataset.

14. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
identifying a sample data point for which a first machine learning (ML) model provides a first prediction with a corresponding first explanation and a second ML model provides the first prediction with a corresponding second explanation, the corresponding second explanation being a target explanation;
generating a set of candidate samples within a specified neighborhood of the sample data point;
selecting a subset of the candidate samples based on a degree of difference between candidate explanations respectively provided for predictions made by the first ML model and the second ML model for the candidate sample; and
retraining the first model by using a revised training dataset including the subset of the candidate samples to cause the first model to provide the target explanation for the first prediction with the sample data point as input.

15. The computer system of claim 14, wherein selecting the subset of the candidate samples is further based on:
a closeness value comparing the sample data point to each candidate sample being above a threshold level of closeness.

16. The computer system of claim 14, wherein:
the first ML model is a whitebox model capable of being directly repaired; and
further comprising:
constraining a gradient of the whitebox model with the target explanation, causing a corresponding explanation of the first prediction to be the target explanation.

17. The computer system of claim 14, further causing the processor set to perform a method comprising:
selecting the second explanation as the target explanation based on user input.

18. The computer system of claim 14, wherein each explanation is represented as a ranked list of input features of each model and weights respectively corresponding input features.

19. The computer system of claim 14, further causing the processor set to perform a method comprising:
modifying a first training dataset by which the first ML model was trained to include the subset of the candidate samples to create the revised training dataset.

20. The computer system of claim 14, wherein:
the first model includes a retrain application programming interface (API) with input data; and
the second model provides a local model around the sample data point, the local model being an interpretable model.
